(19) United States
(12) Patent Application Publication
(10) Pub. No.: US 2010/0300176 A1
(43) Pub. Date: Dec. 2, 2010

(54) MEASURING APPARATUS FOR ANTI-ABRASION PROPERTY

(75) Inventor: BING-JUN ZHANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/549,372

(22) Filed: Aug. 28, 2009

(30) Foreign Application Priority Data
May 27, 2009 (CN) 200910302697.7

(51) Int. Cl. G01N 3/56

(52) U.S. Cl. 73/7

(57) ABSTRACT

A measuring apparatus is provided to measure anti-abrasion property of an object. The measuring apparatus includes a fixing assembly to fix the object, and a friction block to abut against the object. A driving unit is connected to the fixing assembly to drive the fixing assembly to slide back and forth. Therefore the friction block is scraped on the object. The moving of the driving unit is controlled by a controlling device, therefore, the moving journey and an amount of moving cycles of the fixing assembly can be precisely controlled.

### BACKGROUND

1. Technical Field

The present disclosure relates to measuring apparatuses and, more particularly, to a measuring apparatus to measure an anti-abrasion property of an object.

2. Description of the Related Art

Anti-abrasion properties of surfaces are critical to consumer electronic products, such as cell phones, moving picture experts group audio layer III (MP3) players, etc. Therefore, manufacturers of the consumer electronic products should measure anti-abrasion properties of their products. According to a conventional measuring method, a friction block is pressed onto a surface of a product to be measured, then an operator manually manipulates the product to slide relative to the friction block back and forth repetitiously over a predetermined count, then, the anti-abrasion properties of the product are decided according to the abrasion degree of the surface of the product.

One disadvantage of the conventional measuring method described above is that the operator cannot precisely control the travel distance and speed of the movement of the product relative to the friction block, therefore, accuracy and reliability of the measuring result is affected. Another disadvantage of the conventional method is that the measuring method is inefficiency and laboriously.

### BRIEF DESCRIPTION OF THE DRAWINGS

FIG. 1 is an exploded, isometric view of a first embodiment of a measuring apparatus, the apparatus including a driving unit, and a friction block loading mechanism.

FIG. 2 is an exploded, isometric view of the driving unit of FIG. 1.

FIG. 3 is an exploded, isometric view of the friction block loading mechanism of FIG. 1.

FIG. 4 is an assembled, isometric view of the measuring apparatus of FIG. 1, and an object to be measured.

FIG. 5 is an assembled, isometric view of a second embodiment of a measuring apparatus, and two objects to be measure.

### DETAILED DESCRIPTION

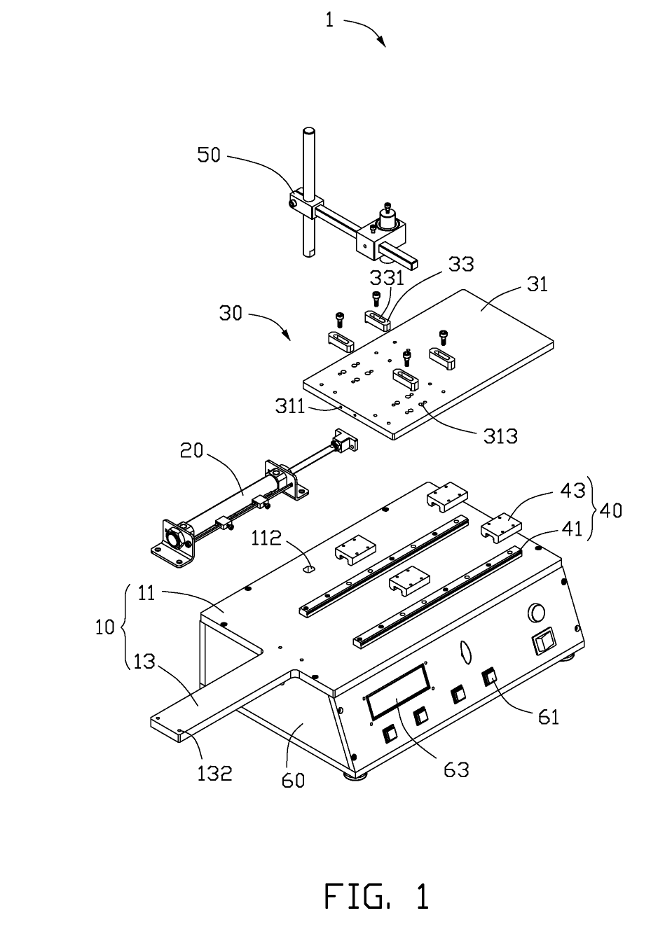

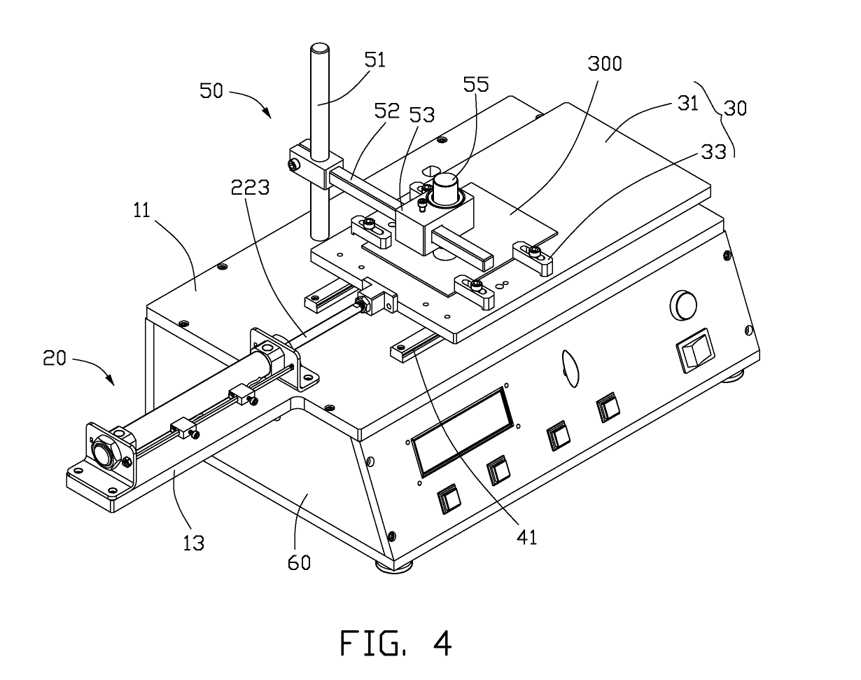

Referring to FIGS. 1 and 4, in a first embodiment, a measuring apparatus 1 is provided to measure an anti-abrasion property of an object 300. The measuring apparatus 1 includes a platform 10, a driving unit 20, a fixing assembly 30, a sliding mechanism 40, a friction block loading mechanism 50, and a controlling device 60.

The platform 10 includes a first plate 11 secured to a top of the controlling device 60, and a second plate 13 extending from a first end of the first plate 11. The first plate 11 defines a fixing hole 112. The second plate 13 and the first end of the first plate 11 define four screw holes 132 correspondingly for securing the driving unit 20.

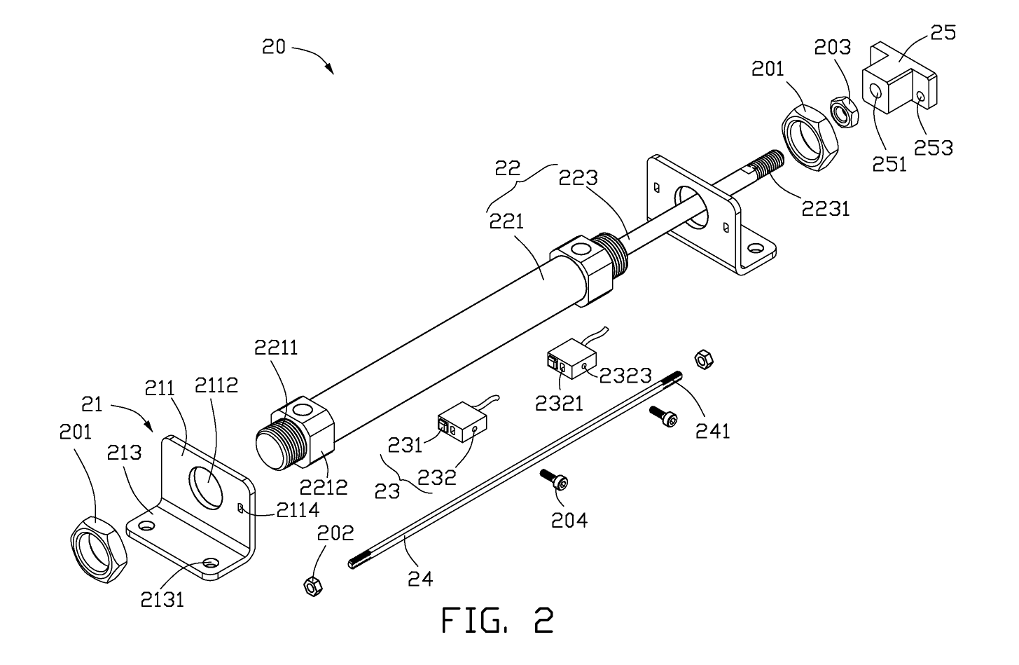

Referring to FIGS. 2, in one embodiment, the driving unit 20 includes two L-shaped brackets 21, a pneumatic cylinder 22, two magnetic switch members 23, a sliding pole 24, a connecting member 25, two screws 204, and a plurality of nuts. Each of the brackets 21 includes a mounting flange 211 and a securing flange 213 perpendicularly extending from a side of the mounting flange 211. The mounting flange 211 defines a mounting hole 2112 in a middle of the mounting flange 211, and a substantially rectangular coupling hole 2114 besides the mounting hole 2112. The securing flange 213 defines two securing holes 2131. The pneumatic cylinder 22 includes a cylindrical body 221, and a plunger 223 retractably received in the cylindrical body 221. The cylindrical body 221 forms two threaded portions 2211 at opposite ends of the cylindrical body 221, and two blocking portions 2212 adjoining the threaded portions 2211, respectively. A magnetic ring (not shown) is received in the cylindrical body 221 and placed around the plunger 223. A threaded portion 2231 is formed at a distal end of the plunger 223. The sliding pole 24 has a double-D shaped cross-section, and forms two threaded portions 241 at opposite ends of the sliding pole 24. Each of the magnetic switch members 23 includes a mounting box 232, and a magnetic switch 231 fixed in the mounting box 232. Each of the mounting box 232 defines a rectangular sliding slot 2321, and a screw hole 2323 perpendicularly communicating with the sliding slot 2321. The magnetic switches 231 are electrically connected to a reverse valve (not shown) of the controlling device 60. The connecting member 25 is T-shaped, and includes a base portion and a protrusion perpendicularly extending from a side of the base portion. Two connecting holes 253 are defined in the base portion at opposite side of the protrusion. A threaded hole 251 is defined the protrusion.

Referring to FIG. 1 again, the fixing assembly 30 includes a carrying plate 31, and a plurality of pressing members 33. Two screw holes 311 are defined in an end surface of the carrying plate 31. Each of the pressing members 33 defines a mounting slot 331. The carrying plate 31 further defines a plurality of screw holes 313 corresponding to the mounting slots 331 of the pressing members 33.

The sliding mechanism 40 includes two parallel slide rails 41 secured to a top of the first plate 11 of the platform 10 opposite to the controlling device 60, and a plurality of carriages 43 slidably mounted to the slide rails 41.

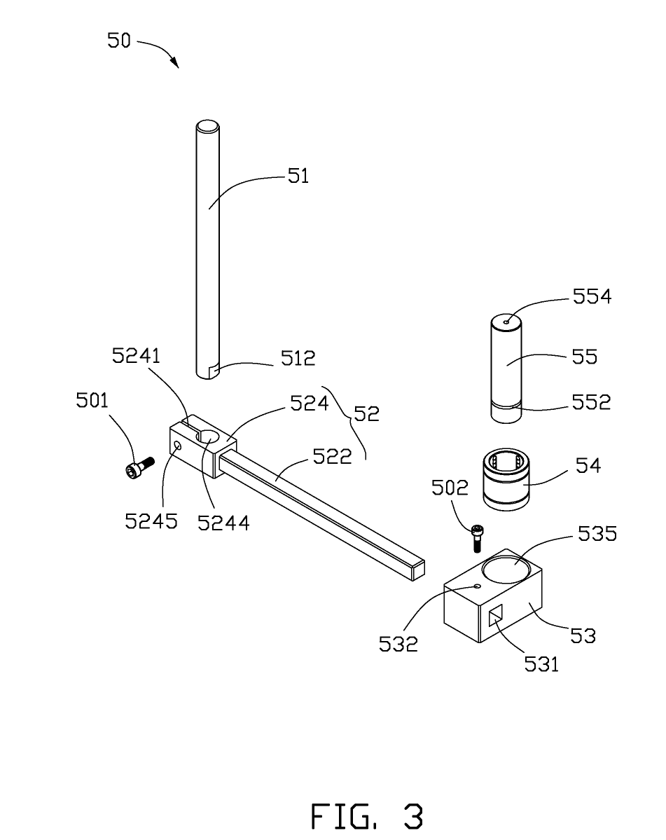

Referring to FIG. 3, the friction block loading mechanism 50 includes a supporting pole 51, a connecting pole 52, a positioning member 53, a linear bearing 54, and a friction block 55. A bottom end of the supporting pole 51 is partially cutout to form a fixing portion 512. The connecting pole 52 includes a pole body 522 and a clamp portion 524 fixed to a first end of the pole body 522. The clamp portion 524 is split into two clamp arms by a slot 5241 defined in the clamp portion 524 and away from the pole body 522. The clamp portion 524 defines a through hole 5244 communicating with the slot 5241. A screw hole 5245 is defined in the clamp portion passing through both of the clamp arms of the clamp portion 524 and communicating with the slot 5241. The positioning member 53 defines a retaining hole 531 adjacent to a first end of the positioning member 53, a screw hole 532 perpendicularly communicating with the retaining hole 531, and a receiving hole 535 adjacent to a second end of the positioning member 53 and parallel to the screw hole 532. The friction block 55 is cylinder-shaped, and defines an circular groove 552 around the outer surface of the friction block 55 adjacent to a bottom end of the friction block 55. A screw hole 554 is defined in a top end of the friction block 554, for cooperating with a screw to attach an additional weight to the friction block 55 if necessary.

The controlling device 60 is electrically connected to the driving unit 20. The controlling device 60 includes a plurality of buttons 61 for operating the driving unit 20, and a screen 63 for displaying measuring statuses (such as travel distance, and repetition count) of the test.

Referring to FIGS. 1-4, in assembly, the threaded portions 2211 of the cylindrical body 221 are inserted into the mounting holes 2112 of the mounting flanges 211 of the corresponding brackets 21 until the blocking portions 2212 abut against the first sides of the mounting flanges 211 opposite to the securing flanges 213 of the mounting flanges 211 correspondingly. Two nuts 201 are engaged with the threaded portions 2211 and resist against second sides opposite to the first sides of the mounting flanges 211, to mount the brackets 21 to opposite ends of the cylindrical body 221. The sliding pole 24 passes through the sliding slots 2321 of the mounting boxes 232 of the magnetic switch members 23, and the threaded portions 241 of the sliding pole 24 respectively pass through the coupling holes 2114 of the mounting flanges 211 of the brackets 21. Two nuts 202 are engaged with the threaded portions 241 of the sliding pole 24 and resist against the second sides of the mounting flanges 211, to retain the sliding pole 24 between the bracket 21. A nut 203 fits about the plunger 223. The connecting member 25 is attached to the plunger 223 by engaging the threaded portion 2231 of the plunger 223 with the threaded hole 251 of the connecting member 25. The nut 203 is tightened against the connecting member 25 to prevent the connecting member 25 from accidentally disengaging from the plunger 223. The driving unit 20 is secured to the second plate 13 of the platform 10, via four screws (not labeled) passing through the securing holes 2131 of the brackets 21 and engaging in the corresponding screw holes 132 of the platform 10. The carrying plate 31 is fixed to the plurality of carriages 43, via fasteners such as screws (not labeled), therefore, the carrying plate 31 is capable of sliding along the slide rails 41. In another embodiment, the carrying plate 31 can also be slidably mounted to the platform 10 in a different way. The carrying plate 31 is connected to the connecting member 25, via screws (not labeled) passing through the connecting holes 253 of the connecting member 25 and engaging in the screw holes 311 of the carrying plate 31. The fixing portion 512 of the supporting pole 51 of the friction block loading mechanism 50 is squeezed into the fixing hole 112 of the platform 10. The connecting pole 52 is coupled to the supporting pole 51, via the supporting pole 51 passing through the through hole 5244 of the clamp portion 524 of the connecting pole 52. The linear bearing 54 is placed in the receiving hole 535 of the positioning member 53. The positioning member 53 is attached to the connecting pole 52, via a second end opposite to the clamp portion 524 of the pole body 522 of the connecting pole 52 passing through the retaining hole 531 of the positioning member 53.

Before measuring, the object 300 is placed on the carrying plate 31, the plurality of pressing members 33 are disposed on the object 300, with the mounting slots 331 of the pressing members 33 aligned with the corresponding screw holes 313 of the carrying plate 31. A plurality of screws (not labeled) pass through the mounting slots 331 of the plurality of pressing members 33 and engage in the corresponding screw holes 313 of the carrying plate 31, to secure the object 300 to the carrying plate 31. The connecting pole 52 is rotatably slid along the supporting pole 51, the positioning member 53 is slid along the pole body 522 of the connecting pole 52 to position the positioning member 53 above the object 300 at a proper height, and align the receiving hole 535 of the positioning member 53 with the object 300. The friction block 55 is slid in the linear bearing 54, therefore the bottom of the friction block 55 abuts against the object 300. Since there is little friction between the linear bearing 54 and the friction block 55, The force applied on the to-be-tested object 300 by the friction block 55 substantially equals the weight of the friction block 55. According to a measuring specification, a rubbing material, such as a cotton cloth dipped with alcohol, is attached to the end of the friction block 55 with a strip engaging with the groove 552 of the friction block 55. A screw 501 is engaged in the screw hole 5245 to tighten the clamp portion 524 of connecting pole 52 to the supporting pole 51. A screw 502 is engaged in the screw hole 532 of the positioning member 53 to abut against the pole body 522 of the connecting pole 52, thereby retaining the positioning member 53 to the pole body 522 of the connecting pole 52. The two magnetic switch members 23 is slid along the sliding pole 24 to predetermined positions, and held at the predetermined position via two screws 204 engaging in the screw holes 2323 of the mounting boxes 232 of the magnetic switch members 23 and abutting against the sliding pole 24, respectively.

In measuring, a button 61 of the controlling device 60 is operated to actuate the pneumatic cylinder 22. The plunger 223 of the pneumatic cylinder 22 extends beyond the cylinder 221 to drive the carrying plate 31 to slide away from the driving unit 20 along the slide rails 41. The friction block 55 scratches the object 300. The magnetic ring of the pneumatic cylinder 22 moves with the plunger 223 to approach a magnetic switch 231 adjacent to the carrying plate 31, until the magnetic switch 231 is actuated to drive the reverse valve. Therefore, the plunger 223 is retracted back to drive the carrying plate 31 to slide backwards, and the friction block 55 is reversely scraped on the object 300. The magnetic ring of the pneumatic cylinder 22 moves with the plunger 22 to approach the other magnetic switch 231 opposite to the carrying plate 31, until the magnetic switch 231 is actuated to drive the reverse valve. As a result, the plunger 223 extends and the carrying plate 31 is slid away from the driving unit 20 again. Accordingly, the friction block 55 scratches the object 300 back and forth repetitiously over a predetermined count. The pneumatic cylinder 22 is stopped and the object 300 is released from the carrying plate 31. The anti-abrasion property of the object 300 is evaluated according to the abrasion degree of the object 300. The travel distance of the object 300 can be adjusted by changing a distance between the two magnetic switch members 23. A counter can be included in the controlling device 60 for setting and adjusting the total repetition count.

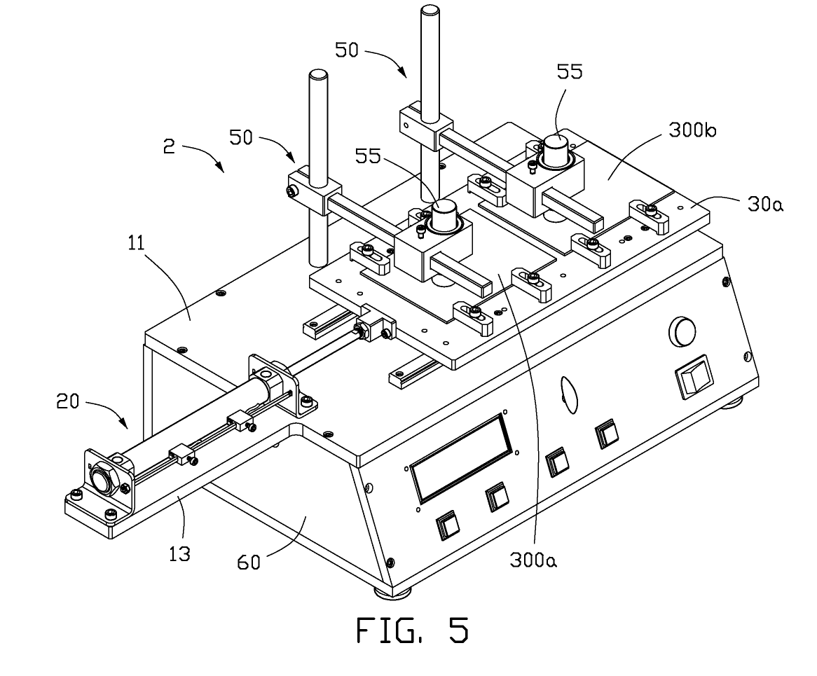

Referring to FIG. 5, in a second embodiment, a measuring apparatus 2 is provided to measure anti-abrasion properties of two objects 300a and 300b. The measuring apparatus 2 includes a fixing assembly 30a and two friction block loading mechanisms 50. The two objects 300a and 300b are both fixed to the fixing assembly 30a. Friction blocks 55 of the two friction block loading mechanisms 50 are respectively positioned to abut against the objects 300a and 300b. Therefore, the measuring apparatus 2 is more efficient by two objects 300a and 300b synchronously.

It is believed that the present embodiments and their advantages will be understood from the foregoing description, and it will be apparent that various changes may be made thereto without departing from the spirit and scope of the description or sacrificing all of its material advantages, the examples hereinbefore described merely being exemplary embodiments.

What is claimed is:

1. A measuring apparatus to measure anti-abrasion property of at least one object, the measuring apparatus comprising:
a platform;
a fixing assembly to secure said at least one object, and the fixing assembly slidably being mounted to the platform;
a friction block loading mechanism comprising a friction block to abut against said at least one object;
a driving unit connected to the fixing assembly; and
a controlling device electrically coupled to the driving unit, wherein the driving unit drives the fixing assembly to slide back and forth related to the friction block under control of the controlling device.

2. The measuring apparatus of claim 1, wherein the driving unit comprises a pneumatic cylinder and two magnetic switch members attached to the pneumatic cylinder, the pneumatic cylinder comprises a cylindrical body secured to the platform, and a plunger retractably mounted to the cylindrical body, the plunger is connected to the fixing assembly, the two magnetic switch members cooperatively defines a sliding journey of the plunger.

3. The measuring apparatus of claim 2, wherein an amount of moving cycles of the plunger is under control of the controlling device.

4. The measuring apparatus of claim 1, further comprising a sliding mechanism disposed between the fixing assembly and the platform, wherein the mechanism comprises two parallel slide rails mounted to the platform, and a plurality of carriages slidably attached to the slide rails, to fix the fixing assembly.

5. The measuring apparatus of claim 4, wherein the fixing assembly comprises a carrying plate connected to the plurality of carriages, and a plurality of pressing blocks fixed to the carrying plate, the carrying plate supports said at least one object, the plurality of pressing blocks abut against said at least one object, thereby retaining said at least one object to the carrying plate.

6. The measuring apparatus of claim 4, wherein the friction block loading mechanism further comprises a supporting pole retained to the platform, a connecting pole fixed to the supporting pole, and a positioning member fixed to the connecting pole and receiving the friction block.

7. The measuring apparatus of claim 6, wherein the supporting pole is substantially perpendicular to the platform, the connecting pole is perpendicular to the supporting pole, the positioning member defines a receiving hole extending perpendicular to the platform, the friction block is movably received in the receiving hole.

8. The measuring apparatus of claim 7, wherein a linear bearing is mounted in the receiving hole of the positioning member, to slidably receive the friction block.

9. The measuring apparatus of claim 7, wherein the friction block defines a screw hole in a top end opposite to the platform, the screw hole of the friction block cooperates with a screw to attach an additional weight to the friction block.

10. The measuring apparatus of claim 7, wherein the friction block defines an annular groove adjacent to a bottom end facing the platform, a rubbing material is attached to the bottom end of the friction block by a tie engaging with the groove.

11. The measuring apparatus of claim 10, wherein the rubbing material is a cotton cloth dipping with alcohol.
